(19) United States
(12) Patent Application Publication
(10) Pub. No.: US 2010/0165123 A1
(43) Pub. Date: Jul. 1, 2010

(54) Data-Driven Video Stabilization

(75) Inventors: Yichen Wei, Beijing (CN); Yasuyuki Matsushita, Beijing (CN)

Correspondence Address: MICROSOFT CORPORATION, ONE MICROSOFT WAY, REDMOND, WA, 98052, US

(73) Assignee: Microsoft Corporation, Remond, WA (US)

(21) Appl. No.: 12/344,599

(22) Filed: Dec. 29, 2008

(51) Int. Cl. H04N 5/228

(52) U.S. Cl. 348/208.4

(57) ABSTRACT

Described is a technology in which existing motion information (e.g., obtained from professional quality videos) is used to correct the motion information of an input video, such as to stabilize the input video. The input video is processed into an original motion chain, which is segmented into original segments. Candidate segments are found for each original segment, and one candidate segment is matched (based on matching criteria or the like) to each original segments. The matched candidates are stitched together to form a changed motion chain that via image warping changes the motion in the output video. Also described is building the data store by processing reference videos into motion information; different data stores may be built based upon styles of reference videos that match a particular style of motion (e.g., action video, scenic video) for the data store.

### BACKGROUND

With the increasing availability of lightweight handheld camcorders and cellular telephones with video cameras, more and more device users shoot videos in daily life. However, because of user shakiness given the casual and handheld nature of such devices, poorly perceived video quality often results from the noisy and undesirable camera motions.

As a result, most modern camcorders are equipped with optical or electronic stabilizers to reduce camera shake. Unwanted camera shake can be further reduced with software-based video stabilization in a post-process that cuts off high frequency image motions. Although different criteria are used for motion smoothing, the goal of video stabilization is essentially either smoothing or freezing the apparent camera movement. However, these techniques only help to smooth the video motion, and are thus limited in what they can accomplish.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which an input video is processed into an output video with changed motion information, based on motion information found in a pre-built data store. In one aspect, predetermined motion information is found that corresponds to (e.g., but is generally smoother than) the original motion information between each of the frames, which may be arranged as segments. The predetermined motion information is used to change the existing motion information, thereby providing a changed video having different motion according to the changed motion information.

In one aspect, the original input video is processed into an original motion chain, which is segmented into original segments. Candidate segments are found for each original segment, and one candidate segment is matched (based on matching criteria or the like) to each original segments. The matched candidates are stitched together to form a changed motion chain that changes the motion in the output video. For example, image warping based on the changed motion information transforms the data in one frame into transformed data in a subsequent frame.

In one aspect, the data store is built by processing reference videos into motion information, and dividing, pruning and/or refining the motion information into the predefined (e.g., sampled) motion information in the data store. Different data stores may be based upon styles of reference videos that match a particular style of motion for the data store.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is block diagram showing example components for data-driven video stabilization.

FIG. 2 is a representation of the creation of s motion chain database from source videos.

FIG. 3 is a representation of the computation of a new motion chain based upon an input video and segments from the motion chain database.

FIG. 4 shows an illustrative example of a computing environment into which various aspects of the present invention may be incorporated.

### DETAILED DESCRIPTION

Various aspects of the technology described herein are generally directed towards improving apparent camera movement of an input video by transferring image motion sequences from other video sources. Unlike traditional motion correction approaches that perform deterministic motion correction, the data of the other video sources, such as professionally-produced films, is used to process input video into smooth and directed motion using a set of predefined motion interpolation methods.

It should be understood that any of the examples described herein are non-limiting examples. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and video processing in general.

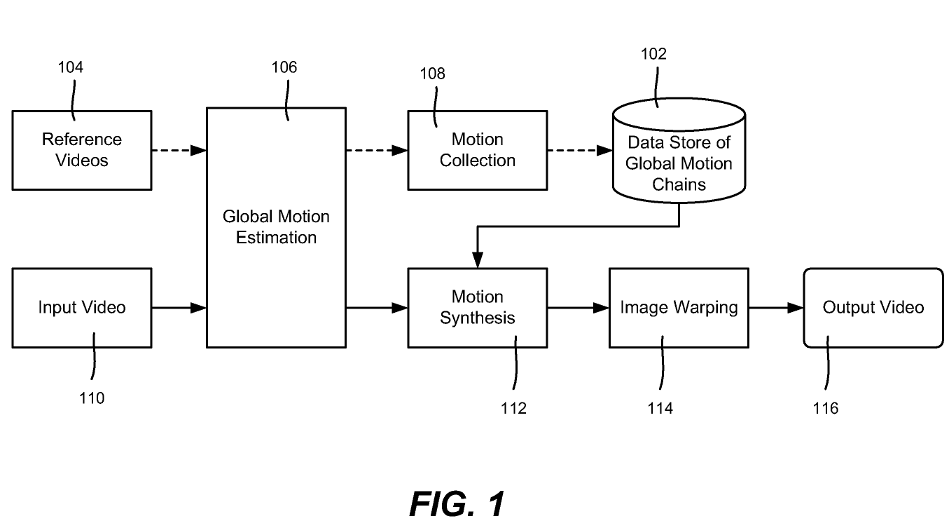

FIG. 1 provides a representation of a data-driven video stabilization mechanism described herein that among other aspects, performs video stabilization; (note that “video” stabilization refers to techniques that remove frame-to-frame jitter in a video, in contrast to “image” stabilization that increases the stability of an image.) In general, the data-driven video stabilization mechanism includes two stages, a motion collection stage and a motion transfer stage, as indicated in FIG. 1 by dashed and solid arrows, respectively.

In the motion collection stage, a data store 102 of image motions is created from reference videos 104. The choice of reference videos is arbitrary. However, good quality reference videos produce good results, so one implementation uses professionally captured videos as the reference videos for the purpose of transferring good motions. From an application point of view, different data stores can be independently prepared using different types of reference videos, e.g., there may be a data store of action videos each with significant amounts of fast motion, a data store of geography/scenery videos with sweeping motions, sports data stores each corresponding to a different type of sports, and so forth. In this way, a certain style of motion can be associated with each data store.

In one implementation, building the data store 102 is accomplished in part by a global motion estimation mechanism 106, such as based on a hierarchical implementation of a known Lucas-Kanade image alignment method to estimate motion for the reference videos 104. In general, this mechanism 106 computes the camera/image motion frame-by-frame (e.g., to detecting things like panning and zooming, relative to the previous frame). As described below, this results in a large chain of sequences of estimated video motion information;

The general goal of the motion collection stage is to create a data store 102 of ‘good’ motions from reference videos, (where ‘good’ may depend on the type of motion that is desirable for a given application). To this end, in one particular implementation, a motion chain is defined as an ordered sequence of transformations M={Mᵢ|i=1, 2, . . . , N-1}. A motion chain captures long range characteristics of camera motions and is a basic element stored in the data store 102.

In one implementation, given a reference video 104 camera motions between every consecutive frame are obtained as a global motion chain R={Rᵢ|i=1, 2, . . . , Nᵣ−1} of the clip, where Nᵣ is the number of frames in the video clip. From a complete motion chain R, sub-sample motion chains R(i, I)={Rᵢ,Rᵢ₊₁, . . . ,R_{i+I}} may be sampled. By varying the starting position i and chain length /, the data store 102 is generated as group of motion chains D={R(i, I)}.

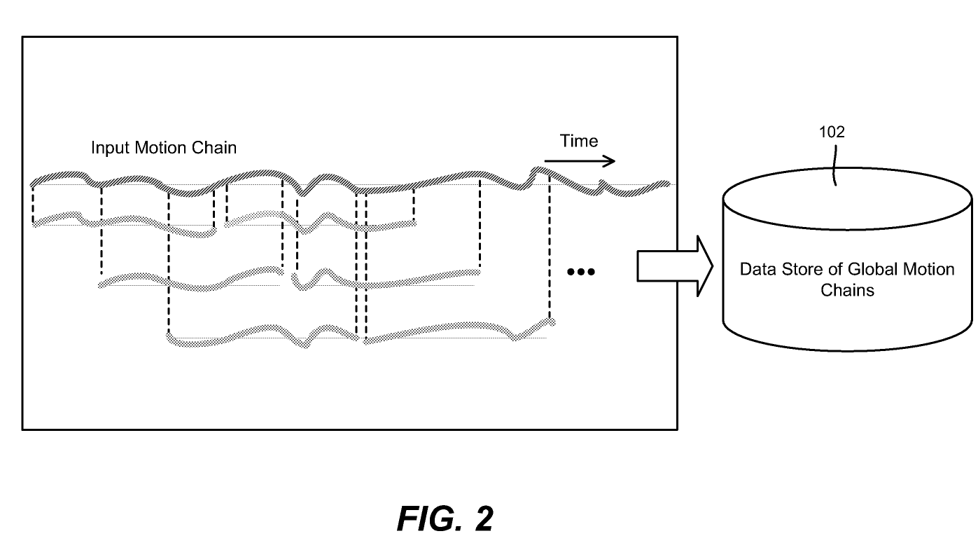

The estimated global motion sequences for the reference videos are divided, pruned and/or refined by a motion collection process (block 108) to create the data store 102. For example, to ensure that the data store only contains ‘good’ or ‘meaningful’ motions (which may vary depending on a given application), known standard shot detection methods may be applied to detect shot boundaries and remove those motion chains across the shot boundaries from the data store 102. A known heuristic (e.g., ‘triple-frame checking’) approach may be used to remove motion estimation noise from the data store 102. Further, to make the data store independent of the spatial size of the videos, the process 108 normalizes the x- and y-translation components by the width and height of the reference videos. The normalization issue is handled similarly in later usage stages. FIG. 2 shows an example of motion chain and sequence concepts.

Once the data store 102 exists, it can be used for processing an input video into a modified video, e.g., with smooth motion and/or special effects, which is referred to as the motion transfer stage. To this end, given an input video 110, new camera motions are computed in a motion synthesis process 112 (following the global motion estimation mechanism 106). The images are warped (block 114) to produce an output video 116. Note that the input video 110 may be an entire video processed as a whole, or may be any portion of a video, e.g., as little as two frames to which the data-driven video stabilization described herein is applied.

In general, the motion transfer stage is directed towards transferring data store motions to enhance the motions of the input video 110. In the motion estimation mechanism 106, given a sequence of input video frames Iᵢ(i=1, 2, . . . , N), the system computes the global transformations between consecutive frame pairs A={Aᵢ|i=1, 2, . . . , N−1}. Each Aᵢ is a 3×3 geometric transformation, referred to as an inter frame motion, such that

Iᵢ(p)≈Iᵢ₋₁(Aᵢ₋₁p) (1)

for any pixel location p=(x, y, 1)^{T}.

The motion synthesis mechanism 112 takes the motions A and uses the data store 102 to enhance the video motion. To this end, new inter-frame motions are generated by composing pre-computed motions from the data store 102. For normal video stabilization processing (e.g., not for special effects purposes), such composition is smooth and resembles the original motions.

In the image warping step of block 114, the motions A are replaced by synthesized new motions to produce the output video. More particularly, the video frames are warped such that the inter-frame motions between warped frames are based on those new motions. Note that like other video stabilization techniques, image warping introduces missing image pixels that are undefined in the warped video frames. Known approaches can be used to fill in the blank areas.

The motion synthesis mechanism 112 generates new motions B={Bᵢ|i=1, 2, . . . , N−1} given original motions A and the data store 102 (also referred to in the equations as D). The new motions are data-driven, as they are composed from motions in the data store. For normal processing, that is, not for special effects, the new motions also have affinity in that they globally resemble the original motion, (this constraint inhibits synthesis of significantly different motions, and discourages simple motion smoothing) and are continuous and smooth (this constraint avoids abrupt motion changes in output video).

For efficient optimization, the first data-driven constraint is treated as a hard constraint. The new motions B are composed by stitching (portions of) motion chains in the data store. The second and third constraints are considered as soft constraints. We define the problem in an energy minimization framework:

$$B = {arg min}_{ℬ} ( {\sum }_{i = 1}^{N} D ( {A}_{i} , {B}_{i} ) + {\sum }_{m , n , m < n} S ( {B}_{m} , {B}_{n} ) ) . \qquad ( 2 )$$

The first term in equation 2 represents the affinity constraint that enforces the similarity between the original and new motions. D is a distance function between two transformation matrices defined as D(A,B)=∥B−A∥₂, where ∥•∥₂ represents the L2-norm. The second term addresses the smoothness constraint. It is defined as:

$$S ( {B}_{m} , {B}_{n} ) = \{ \begin{matrix}0 & if ∃ ∈ , ‖ {ℬ}^{} ( m , n ) - ‖ < ε \\ {w}_{s} ( n - m ) {‖ {B}_{m} - {B}_{n} ‖}_{2} & otherwise .\end{matrix} \qquad ( 3 )$$

The first case states that the motion chain from m to n R^{B}(m, n)={Bₘ,Bₘ₊₁, . . . , Bₙ} can be accepted with no penalty if it is close enough (∈ is a small constant) to some motion chain in the data store. Otherwise, a smoothness penalty is added as stated in the second case; wₛ(m−n) is a weighting factor that is larger when indices m and n are closer, e.g.,

$${w}_{s} ( x ) = {e}^{- \frac{{x}^{2}}{2 {σ}_{w}}} ,$$

so as to not impose strong smoothness constraints for faraway motions.

Optimizing Equation (2) is not straightforward. On one extreme, since each Bᵢ can take on many possible values, the state space of B is huge and an exhaustive search is impractical. On the other extreme, any portion of A may be replaced with the most similar (best matching) counterpart in the data store 102. However, there are potentially a huge number of motion chains, possibly overlapping with each other, and every frame position is included in many chains. It is thus relatively difficult to design optimal strategies, such as which motion chain to choose and how to set motion chain parameters such as length and sampling rate.

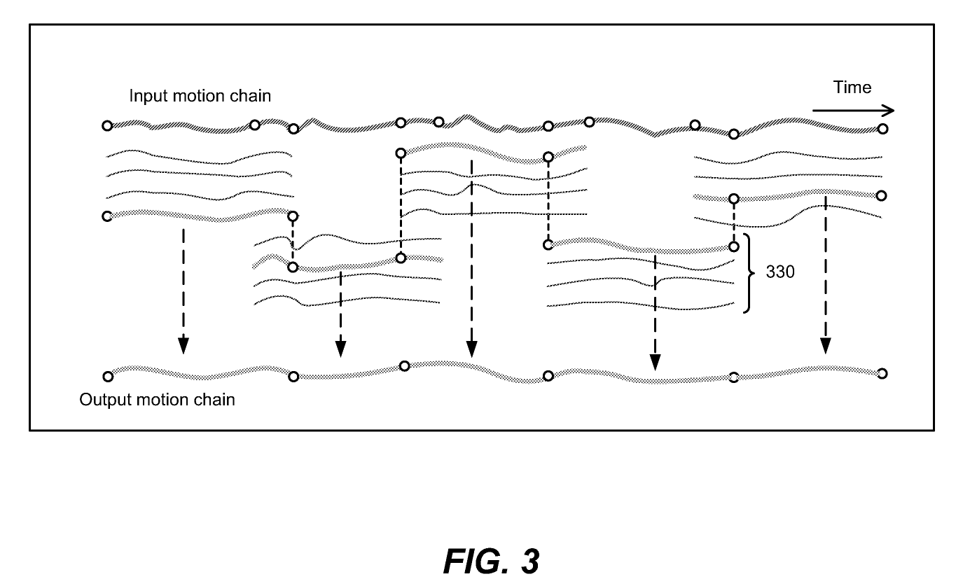

A hybrid optimization approach is used to address the above issues, as illustrated in FIG. 3. To this end, a set of sub-sampled motion chains Aᵢ from A is first computed using a sliding window, in a similar way as performed in the data store creation stage. For each Aᵢ, the k nearest motion chains Dᵢ^{j}, j=1, . . . , k, where j is a candidate index, are found from the data store by a well-known, efficient k-nearest neighbors search. All such motion chains Dᵢ^{j} constitute a set of candidates {Dᵢ} for each Aᵢ; in the example of FIG. 3 one set of four candidate chains for the segment of the illustrated length is labeled 330, in which the chosen candidate of the four lines is shown as the thicker gray line.

To determine a segment of the new motion chain Bᵢ which corresponds to Aᵢ, the segment Bᵢ is restricted to be contained in a motion chain in {Dᵢ}. In this way, the answer space of B is significantly reduced. The answer space may be further restrained by restricting the smoothness term of Equation (3) to only consider consecutive frame pairs:

$$S ( {B}_{i - 1} , {B}_{i} ) = \{ \begin{matrix}0 & if [ {B}_{i1 -} , {B}_{i} ] is a portion of a motion chain in D \\ ∞ & if {B}_{i - 1} and {B}_{i} are from middle \\ & of different motion chains in D \\ {‖ {B}_{i - 1} , {B}_{i} ‖}_{2} & otherwise ,\end{matrix} \qquad ( 4 )$$

The second case in Equation (4) states that switching between different data store motion chains can only happen at the ends of chains, prohibiting frequent jumps between chains, as in FIG. 3. Consequently, the cost function of Equation (2) is simplified to:

$$B = {arg min}_{ℬ} ( {\sum }_{i = 1}^{N} D ( {A}_{i} , {B}_{i} ) + {λ}_{s} {\sum }_{i = 2}^{N} S ( {B}_{i - 1} , {B}_{i} ) ) \qquad ( 5 )$$

A standard dynamic programming approach is used to efficiently optimize equation (5).

Turning to computation of optimal image warping transformations, in the image warping stage, given the new motions B, the system works to replace the original motions A to generate the new video. To this end, video frames Iᵢ are warped using image warping transformations X={Xᵢ, i=1, 2, . . . , N},

Iᵢ*(p)=Iᵢ(Xᵢp) (6)

where Iᵢ* is the warped image. The inter-frame motions in the output video I* are equal to B, that is:

Iᵢ*(p)=Iᵢ₋₁*(Bᵢ₋₁p) (7)

From Equations (6) and (7):

Iᵢ(Xᵢp)=Iᵢ₋₁(Xᵢ₋₁Bᵢ₋₁p) (8)

Therefore, the following relationship can be derived using Equations. (1) and (8):

Aᵢ₋₁Xᵢ=Xᵢ₋₁Bᵢ₋₁. (9)

Note that A and B are known and X is unknown. When the transformation matrix has d degrees of freedom (e.g., d=2 for pure translation), every equation in the form of Equation (9) imposes d independent constraints on the unknown entries of X. There are d(N−1) constraints total, but only dN unknowns (all Xᵢ are to be solved), so the problem is under-constrained.

To uniquely determine the transformations X, a soft constraint is used that forces X to become close to the identity matrix to regulate the magnitude of the warping. In this way, the problem of estimating X can be written as an optimization problem:

$$χ = {arg min}_{χ} ( {\sum }_{i = 1}^{N} {‖ {X}_{i} - I ‖}_{2} + {λ}_{w} {\sum }_{i = 2}^{N} {‖ {A}_{i - 1} {X}_{i} - {X}_{i - 1} {B}_{i - 1} ‖}_{2} ) \qquad ( 10 )$$

The two terms in the equation address the soft and hard constraints, respectively. The weighting factor λ_{w} is set to a large value to ensure that the hard constraint in Equation (9) is satisfied.

In a pure translation case, d=2; when the transformations are purely translations, then:

$$A = ( \begin{matrix}{I}_{2 \times 2} & {t}^{A} \\ {0}_{1 \times 2} & 1\end{matrix} ) , B = ( \begin{matrix}{I}_{2 \times 2} & {t}^{B} \\ {0}_{1 \times 2} & 1\end{matrix} ) , and X = ( \begin{matrix}{I}_{2 \times 2} & t \\ {0}_{1 \times 2} & 1\end{matrix} )$$

$$where {( {t}_{x}^{A ( B )} , {t}_{y}^{A ( B )} )}^{T} .$$

This gives Equation (9) as

tᵢ₋₁^{A}+tᵢ=tᵢ₋₁+tᵢ₋₁^{B}, or, tᵢ−tᵢ₋₁=tᵢ₋₁^{B}−tᵢ₋₁^{A}=Δta constant). (11)

The cost function (10) is simplified to:

$$( {t}_{1} , … , {t}_{N} ) = {arg min}_{( {t}_{1} , … , {t}_{N} )} ( {\sum }_{i = 1}^{N} {‖ {t}_{i} ‖}_{2} + λ {\sum }_{i = 2}^{N} {‖ {t}_{i} - {t}_{i - 1} - Δ t ‖}_{2} ) . \qquad ( 12 )$$

Equation (12) leads to a linear system Ct_{x(y)}=b_{x(y)}. The x and y component of the translation vector can be solved in a least-square sense using the normal equation C^{T}Ct_{x(y)}=C^{T}bt_{x(y)}.

In a similarity transformation case, d=4, as similarity transformations have two additional parameters, the rotation angle θ and scale s. The top-left left 2×2 block of a similarity transformation is:

$$S = s ( \begin{matrix}cos ( θ ) & - sin ( θ ) \\ sin ( θ ) & cos ( θ )\end{matrix} ) , or$$

may be linearly parameterized by two parameters:

$$S = ( \begin{matrix}p & - q \\ q & p\end{matrix} ) .$$

### Letting

$$A = ( \begin{matrix}{S}^{A} & {t}^{A} \\ {0}_{1 \times 2} & 1\end{matrix} ) , \\ B = ( \begin{matrix}{S}^{B} & {t}^{B} \\ {0}_{1 \times 2} & 1\end{matrix} ) , \\ and X = ( \begin{matrix}S & t \\ {0}_{1 \times 2} & 1\end{matrix} ) , \qquad equation ( 9 )$$

may be rewritten as:

$$( \begin{matrix}{S}_{i - 1}^{A} {S}_{i} & {S}_{i - 1}^{A} {t}_{i} + {t}_{i - 1}^{A} \\ {0}_{1 \times 2} & 1\end{matrix} ) = ( \begin{matrix}{S}_{i - 1} {S}_{i - 1}^{B} & {S}_{i - 1} {t}_{i - 1}^{B} + {t}_{i - 1} \\ {0}_{1 \times 2} & 1\end{matrix} ) . \qquad ( 13 )$$

The cost function (10) becomes:

$$( {S}_{i} , {t}_{i} ) = {arg min}_{( {S}_{i} , {t}_{i} )} ( \begin{matrix}{\sum }_{i = 1}^{N} ( {‖ {S}_{i} - {I}_{2 \times 2} ‖}_{2} + {‖ {t}_{i} ‖}_{2} ) + \\ λ {\sum }_{i = 2}^{N} ( \begin{matrix}{‖ {S}_{i - 1}^{A} {S}_{i} - {S}_{i - 1} {S}_{i - 1}^{B} ‖}_{2} + \\ {‖ {S}_{i - 1}^{A} {t}_{i} + {t}_{i - 1}^{A} - {S}_{i - 1} {t}_{i - 1}^{B} - {t}_{i - 1} ‖}_{2}\end{matrix} )\end{matrix} ) \qquad ( 14 )$$

Note that the terms in Equation (14) are linear in terms of the unknowns (Sᵢ, tᵢ). As before, the optimization can be solved in a least-square sense.

In an affine transformation case, d=6. In a more general form, the transformation is a 6 degree of freedom affine matrix. The left-top 2×2 block has four parameters,

$$S = ( \begin{matrix}a & b \\ c & d\end{matrix} ) .$$

It is straightforward to show that the solution of Eq. (10) can be obtained in a least-square sense, in a similar way as was done for Equations (12) and (14).

There is thus provided a technology for correcting apparent camera movement with a data-driven approach, as well as techniques for motion synthesis and image warping. The technology provides an adaptive strategy that works for various different kinds of input videos via a data store of image motions that are obtained from reference videos.

By creating different motion databases that carry different styles of motion, more complex effects in motion synthesis may be provided. For example, action movies usually contain large motion changes, sometimes intentionally shaky. Using a database containing these motions, the technology is able to perform ‘destabilization’, that is, creating shaky videos out from stable-motion videos. Other special effects may be implemented.

### Exemplary Operating Environment

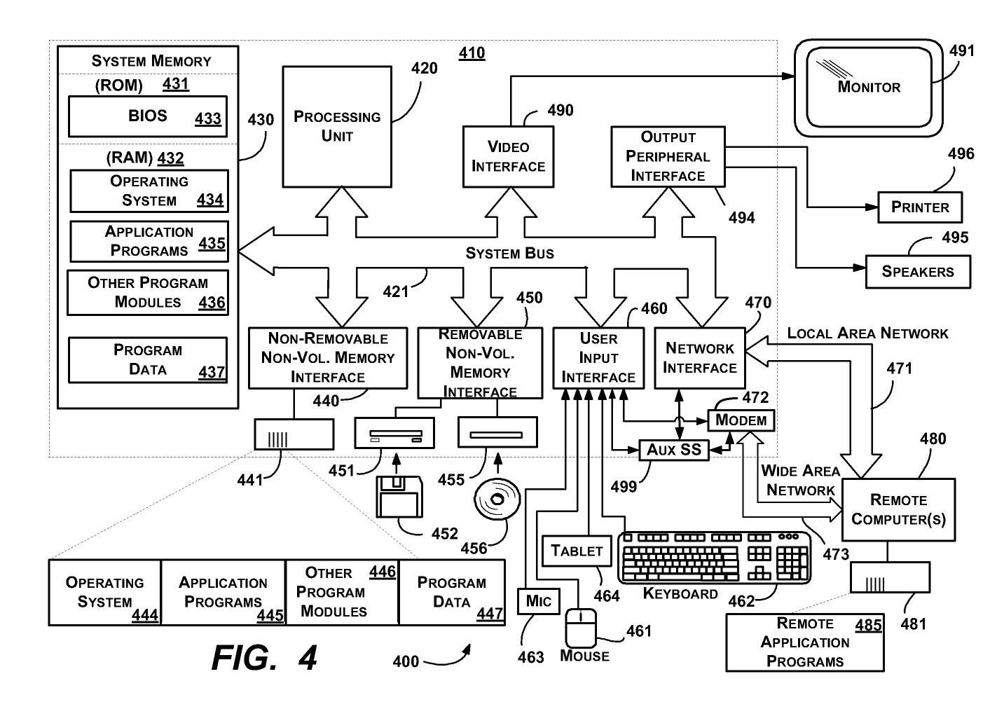

FIG. 4 illustrates an example of a suitable computing and networking environment 400 on which the examples of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component 474 such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a method comprising, inputting a video comprising a set of frames, determining existing motion information between each of the frames, locating other motion information from a data store of motion information, applying the other motion information to change the existing motion information between each of the frames into changed motion information, and outputting a changed video having the changed motion information.

2. The method of claim 1 wherein the existing motion information between each of the frames comprises a motion chain, and further comprising dividing the motion chain into a plurality of original segments.

3. The method of claim 2 wherein locating the other motion information comprises finding candidate segments for at least some of the original segments, and selecting corresponding segments from the candidate segments.

4. The method of claim 1 wherein applying the other motion information comprises performing image warping based on the changed motion information to transform data in one frame into transformed data in a subsequent frame.

5. The method of claim 1 wherein locating the other motion information comprises constraining the other motion information so as to have affinity with the original motion information.

6. The method of claim 1 wherein locating the other motion information comprises constraining the other motion information so as to be close in continuity and smoothness with the original motion information.

7. The method of claim 1 further comprising, building the data store, including processing reference videos into motion information, dividing, pruning or refining the motion information, or any combination of dividing, pruning or refining the motion information into sampled motion information, and maintaining the sampled motion information in the data store.

8. The method of claim 7 wherein building the data store comprises using reference videos that match a particular style of motion for the data store.

9. In a computing environment, a system comprising, a data store of predetermined motion information, a motion estimation mechanism that processes frames of input video into existing motion information for that input video, a motion synthesis mechanism coupled to the data store that selects sets of predetermined motion information corresponding at least some of the existing motion information, and an image warping mechanism that modifies at least some of the existing motion information with corresponding predetermined motion information as selected by the motion synthesis mechanism into modified motion information.

10. The system of claim 9 wherein the existing motion information between each of the frames comprises a motion chain, and wherein the motion synthesis mechanism divides the motion chain into a plurality of original segments, finds candidate segments for at least some of the original segments, and selects corresponding segments from the candidate segments.

11. The system of claim 9 wherein the image warping mechanism transforms data in one frame into transformed data in a subsequent frame based on the modified motion information.

12. The system of claim 9 wherein the motion synthesis mechanism selects the sets of predetermined motion information within one or more constraints.

13. The system of claim 12 wherein the one or more constraints include an affinity constraint, or a smoothness constraint, or both an affinity constraint and a smoothness constraint.

14. The system of claim 9 further comprising, means for building the data store, including a global estimation mechanism that processes reference videos into motion information, and a motion collection mechanism that divides, prunes and/or refines the motion information into the predetermined motion information.

15. The system of claim 9 wherein the data store corresponds to a style of motion information that is common among a set of reference videos used to build the data store.

16. One or more computer-readable media having computer-executable instructions, which when executed perform steps, comprising:
inputting a video comprising a set of frames;
determining an original motion chain between each of the frames;
dividing the motion chain into a plurality of original segments, each segment having associated motion information;
locating predetermined motion information for each original segment based upon the motion information corresponding to that segment;
applying the predetermined motion information to change the associated motion information of each segment into changed motion information; and
outputting a changed video having the changed motion information.

17. The one or more computer-readable media of claim 16 wherein applying the other motion information comprises performing image warping based on the changed motion information to transform data in one frame into transformed data in a subsequent frame.

18. The one or more computer-readable media of claim 16 wherein locating the other motion information comprises finding candidates for each segment, and selecting a candidate based upon matching at least one criterion.

19. The one or more computer-readable media of claim 16 wherein locating the other motion information comprises following at least one constraint.

20. The one or more computer-readable media of claim 16 having further computer-executable instructions comprising building the data store, including processing reference videos.
